(19) United States
(12) Patent Application Publication
(10) Pub. No.: US 2024/0283761 A1
(43) Pub. Date: Aug. 22, 2024

(54) STORAGE MEDIUM STORING PROGRAM FOR DISPLAYING VOICE MESSAGE, CONTROL METHOD, AND INFORMATION PROCESSING APPARATUS

(71) Applicant: CANON KABUSHIKI KAISHA, Tokyo (JP)

(72) Inventor: TAKU SHINOHARA, Saitama (JP)

(21) Appl. No.: 18/581,933

(22) Filed: Feb. 20, 2024

(30) Foreign Application Priority Data
Feb. 22, 2023 (JP) 2023-025959

(51) Int. Cl. H04L 51/04; G10L 15/26; H04L 51/10; H04M 1/72433

(52) U.S. Cl. CPC H04L 51/04; G10L 15/26; H04L 51/10; H04M 1/72433

(57) ABSTRACT

A storage medium storing a program for causing a computer to execute a control program for controlling an information processing apparatus, which makes it possible to confirm the content of a voice message in a chat room even in a case where the voice message cannot be reproduced. The information processing apparatus is caused to receive an instruction for converting content of a voice message in a chat room where chats are posted by a plurality of users into characters, execute processing for converting the content of the voice message into characters, and display the characters in a state associated with the voice message in the chat room, based on the instruction.

### BACKGROUND OF THE INVENTION

### Field of the Invention

The present invention relates to a storage medium storing a program for displaying a voice message, a control method, and an information processing apparatus.

### Description of the Related Art

In recent years, communication between users using a chat system has become popular. This chat system provides a service that makes it possible to perform communication, by transmitting not only characters but also a voice message from a sending person side, and reproducing the voice message on a receiving person side. Further, a technique disclosed in Japanese Laid-Open Patent Publication (Kokai) No. 2021-110911 is an apparatus in which, as handling of voice data, a recognition processor converts input voice data to text data and displays the text data as characters which can be recognized by a display section (see, for example, Japanese Laid-Open Patent Publication (Kokai) No. 2021-110911).

However, there is a problem that the voice message displayed on a chat window of the chat system is only displayed as an icon for reproducing the voice message, and the content of the message cannot be confirmed until the voice is reproduced. For example, in a place where outputting of sound is inhibited, it is impossible to immediately confirm the message. On the other hand, if the voice data is all converted to characters for display as performed in the apparatus disclosed in Japanese Laid-Open Patent Publication (Kokai) No. 2021-110911, there is a problem that the visibility is degraded.

### SUMMARY OF THE INVENTION

The present invention provides a storage medium storing a program for causing a computer to execute a control program for controlling an information processing apparatus, which makes it possible to confirm the content of a voice message in a chat room even in a case where the voice message cannot be reproduced, a control method, and an information processing apparatus.

In a first aspect of the present invention, there is provided a non-transitory computer-readable storage medium storing a program for causing a computer to execute a method of controlling an information processing apparatus, the control method including receiving an instruction for converting content of a voice message in a chat room where chats are posted by a plurality of users into characters, causing the information processing apparatus to execute processing for converting the content of the voice message into characters, and causing the information processing apparatus to display the characters in a state associated with the voice message in the chat room, based on the instruction.

In a second aspect of the present invention, there is provided an information processing apparatus including a reception unit configured to receive an instruction for converting content of a voice message in a chat room where chats are posted by a plurality of users into characters, an execution unit configured to execute processing for converting the content of the voice message into characters, and a display control unit configured to display the characters in a state associated with the voice message in the chat room, based on the instruction.

Further features of the present invention will become apparent from the following description of exemplary embodiments (with reference to the attached drawings).

### BRIEF DESCRIPTION OF THE DRAWINGS

FIG. 1 is a diagram showing the configuration of a system according to a first embodiment of the present invention.

FIG. 2 is a block diagram showing the configuration of a chat application server in the present embodiment.

FIG. 3 is a block diagram showing the configuration of each of mobile terminals in the present embodiment.

FIGS. 4A to 4C are diagrams each useful in explaining an operation screen of a chat application in the present embodiment.

FIG. 5 is a flowchart of a message transmission/reception process performed by the chat application server in the present embodiment.

FIG. 6 is a flowchart of a message reception process performed by the mobile terminal in the present embodiment.

FIG. 7 is a flowchart of a read message transmission process for transmitting a read message to the chat application server when a message is displayed in a chat room of the mobile terminal.

FIG. 8 is a flowchart of a read-state information reception process performed by the mobile terminal in the present embodiment.

FIG. 9 is an explanatory diagram showing a chat management table in the present embodiment.

FIG. 10 is an explanatory diagram showing a sequence of operations performed by the whole chat system in the present embodiment.

FIG. 11 is a flowchart of a text message-displaying process performed by the mobile terminal in the first embodiment.

FIG. 12 is an explanatory diagram showing the display of the chat room in the present embodiment.

FIG. 13 is an explanatory diagram showing the display of the chat room in the present embodiment.

FIG. 14 is an explanatory diagram showing the display of the chat room in the present embodiment.

FIG. 15 is a flowchart of a first variation of the text message-displaying process performed by a mobile terminal in a second embodiment of the present invention.

FIG. 16 is a flowchart of a second variation of the text message-displaying process performed by the mobile terminal in the present embodiment.

FIG. 17 is an explanatory diagram showing the display of the chat room in the present embodiment.

FIG. 18 is a flowchart of a text message-deleting process performed by the mobile terminal in the present embodiment.

FIG. 19 is a flowchart of a third variation of the text message-displaying process performed by a mobile terminal in a third embodiment of the present invention.

FIG. 20 is an explanatory diagram showing the display of the chat room in the present embodiment.

FIG. 21 is a flowchart of a fourth variation of the text message-displaying process performed by a mobile terminal in a fourth embodiment of the present invention.

FIG. 22 is an explanatory diagram showing the display of the chat room in the present embodiment.

### DESCRIPTION OF THE EMBODIMENTS

The present invention will now be described in detail below with reference to the accompanying drawings showing embodiments thereof. The following description of the configuration of the embodiments is given by way of example, and the scope of the present invention is not limited to the described configuration of the embodiments. First, a first embodiment of the present invention will be described.

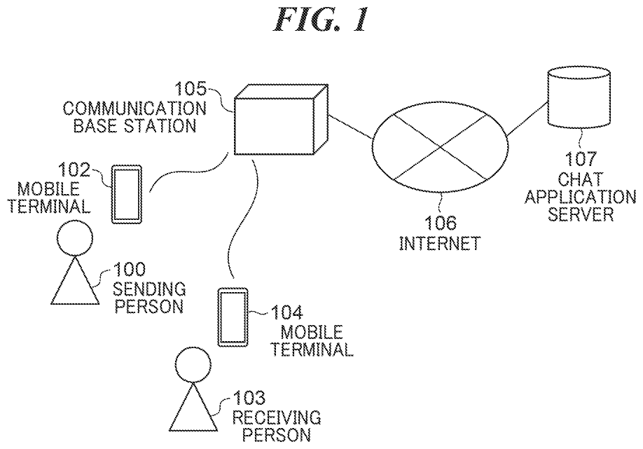

FIG. 1 is diagram showing an example of the configuration of a system according to the first embodiments of the present invention. This system includes a communication base station 105 and a chat application server 107, and these are communicably connected to each other via the Internet 106. The communication base station 105 communicates necessary information with a mobile terminal 102 owned by a sending person 100 and a mobile terminal 104 owned by a receiving person 103.

The sending person 100 sends a voice message by a chat application installed in the mobile terminal 102. Next, the voice message sent by the sending person 100 is transmitted to the chat application server 107 via the communication base station 105 and the Internet 106. Next, the chat application server 107 performs predetermined processing on the received voice message and transmits the processed voice message to a destination. Then, the voice message transmitted by the chat application server 107 is transmitted to the mobile terminal 104 owned by the receiving person 103 via the Internet 106 and the communication base station 105.

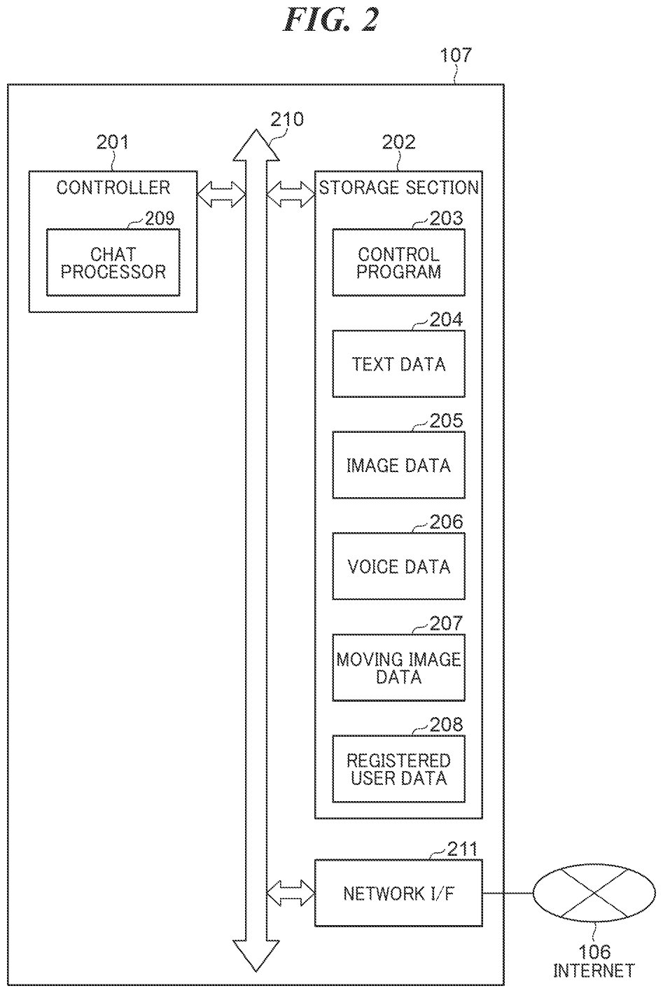

FIG. 2 is a block diagram showing the configuration of the chat application server 107 according to the present embodiment. The chat application server 107 includes a controller 201, a storage section 202, and a network interface 211, and these components are connected by a system bus 210 in a state enabled to transmit and receive necessary information to and from each other.

The controller 201 loads and executes a control program 203 non-volatily stored in the storage section 202. With this, a variety of functions necessary for the chat application server 107 are realized. The controller 201 is comprised of at least one processor, such as a central processing unit (CPU) or a digital signal processor (DSP). Further, the controller 201 includes a chat processor 209 and performs centralized control of the devices connected to the system bus 210. The chat processor 209 interprets a message received from the chat application of the mobile terminal 102 and sends a response. Thus, the chat application server 107 has an automatic interaction function and also functions as a chatbot.

The storage section 202 (storage unit) is used as an internal storage. The storage section 202 stores the control program 203, text data 204, image data 205, voice data 206, moving image data 207, registered user data 208, system software, and so forth. The storage section 202 is implemented by a storage device, such as a hard disk drive (HDD), a solid-state drive (SSD), or a random-access memory (RAM).

The text data 204 is text data of messages posted by users or chatbots in chats. The image data 205 is image data posted by users in chats. The voice data 206 is voice data of voice messages posted by users in chats. The moving image data 207 is moving image data of moving image messages posted by users in chats. The registered user data 208 is list information of combinations of user IDs and passwords, each required when each user logs in the chat application.

The network interface 211 is an interface that is connected to the Internet 106 via, for example, a local area network (LAN) cable to perform network communication. For example, a well-known network card or the like can be used.

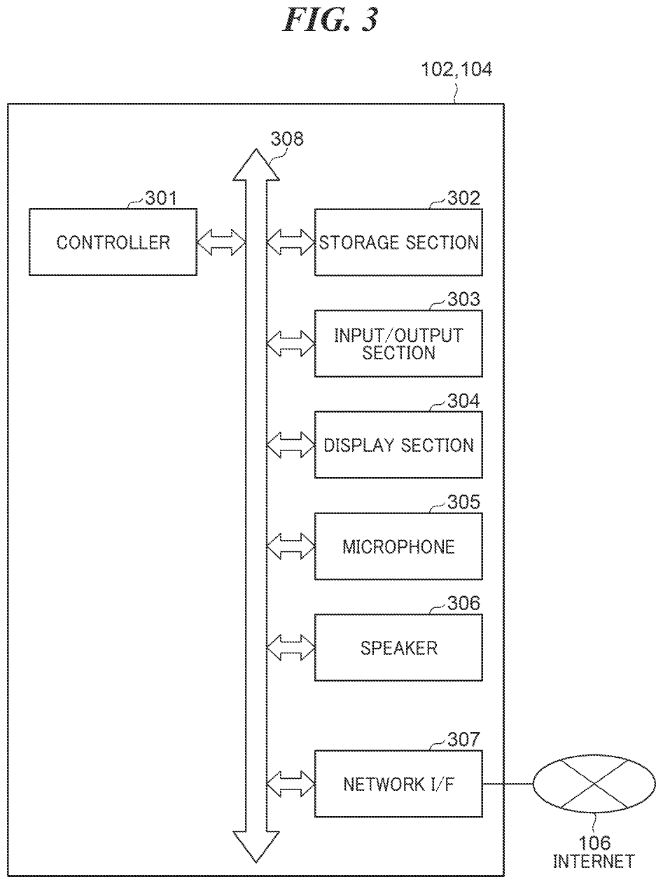

FIG. 3 is a block diagram showing the configuration of each of the mobile terminals 102 and 104. Note that the mobile terminals 102 and 104 are each an example of an information processing terminal which has a communication function and is capable of being used in a free place by being equipped with a wireless communication function or the like. For example, a smartphone, a tablet terminal, a laptop PC, or the like is used.

Both of the mobile terminals 102 and 104 have the same configuration, and hence the configuration of the mobile terminal 102 will be described as a representative. The mobile terminal 102 has a system bus 308. To the system bus 308, a controller 301, a storage section 302, an input/output section 303, a display section 304 (display unit), a microphone 305, a speaker 306, and a network interface 307 are connected. The devices connected to the system bus 308 are enabled to transmit and receive necessary information to and from each other.

The controller 301 loads and executes control programs non-volatily stored in the storage section 302. With this, a variety of functions necessary for the mobile terminal 102 are realized. The controller 301 is comprised of at least one processor, such as a CPU or a DSP. Further, the controller 301 performs centralized control of the devices connected to the system bus 308.

The storage section 302 is used as an internal storage. The storage section 302 stores control programs, text data, voice data, image data, system software, and so forth. The storage section 302 is implemented by a storage device, such as an HDD, an SSD, or a RAM.

The input/output section 303 is implemented, for example, by a liquid crystal display (LCD) touch panel, for acquiring information input by a user operation and sending the acquired information to the controller 301. Further, the input/output section 303 outputs a result of processing performed by the controller 301. Note that an operation of input from a user can be realized by a hardware input device, such as a switch and a keyboard. As a method of detecting an input to the touch panel, for example, a general detection method, such as a resistance film method, an infrared method, an electromagnetic induction method, or an electrostatic capacitance method, can be employed.

The display section 304 performs the display according to image data. Further, the display section 304 can display an operation screen and provides a user interface (UI) to a user. The microphone 305 is used to input voice data. The speaker 306 is used to output voice data. In the present embodiment, a speaker incorporated in the mobile terminal 102 is used to output voice. Further, the controller 301 can send voice to a voice output device, such as an external earphone or a speaker, which is connected to the mobile terminal 102 from the outside, to cause the voice output device to output the voice. The network interface 307 is connected to the Internet 106 to perform network communication.

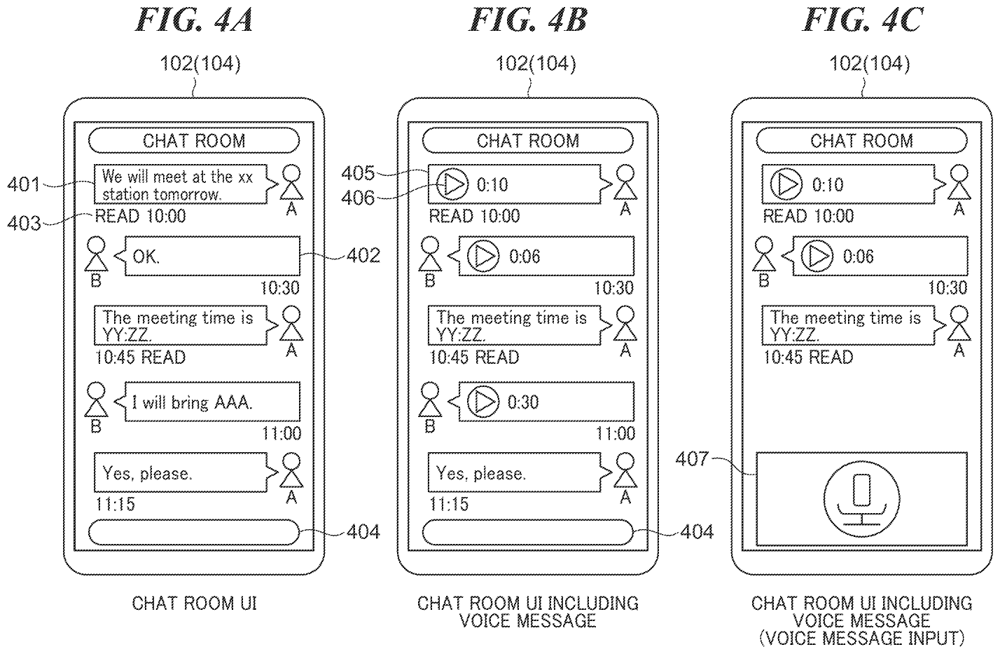

FIG. 4A is an explanatory diagram showing an operation screen of the chat application operating on each of the mobile terminals 102 and 104. At the time of appearance of this operation screen, the chat application is performing necessary communication with the chat application server 107. On the operation screen shown in FIG. 4A, a message 401 of a user A (operator of the present mobile terminal) and a message 402 (chat partner) of a user B are displayed in time series in a vertical downward direction of the screen. Although in the present embodiment, the message 402 of the chat partner (user B) is displayed on the right side of a user icon displayed at a left end of the display screen, similarly to the message 401 of the user A, it can be displayed on the left side of a user icon displayed at a right end of the display screen.

On the display screen shown in FIG. 4A, a character string “read” (403) which indicate that the message sent by the user A is displayed by the user B as the chat partner is also displayed on the display screen. Further, as shown in FIG. 4A, a message input field 404 is displayed in a lower portion of the display screen. In the message input field 404, the user inputs text and/or selects image data stored in the storage section 302 and transmits the text and/or image data to the chat application server. With this, the message is transmitted to the user B.

FIG. 4B is an explanatory diagram showing an operation screen of the chat application, including a voice message.

A voice message 405 is displayed differently from text messages, and a button (button icon) 406 for reproducing voice is displayed. Assuming that the user A of the mobile terminal 102 is displaying the operation screen of FIG. 4B, when a voice reproduction instruction is received from the user A who has pressed the button 406, the controller 301 of the mobile terminal 102 performs voice reproduction control. With this, the reproduced voice is output from the speaker 306.

FIG. 4C is an explanatory diagram showing an operation screen for inputting a voice message. When a user presses a voice message input field 407, the chat application starts recording of voice. Assuming that the user A of the mobile terminal 102 is displaying the operation screen of FIG. 4C, the user A inputs voice to the microphone 305 of the mobile terminal 102. To terminate inputting of voice, the user presses the voice message input field 407 again. The chat application stops recording of voice and stores voice message data in the storage section 302. After that, by transmitting the voice message to the chat application server according to a user's instruction, the voice message is transmitted to the receiving person.

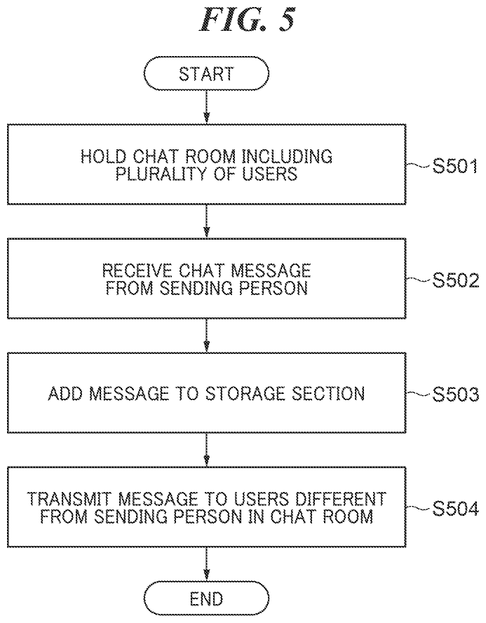

Next, the operation of a message transmission/reception process performed by the chat application server 107 will be described with reference to FIG. 5. The message transmission/reception process in FIG. 5 is realized by the controller 201 (CPU) of the chat application server 107 loading the control program 203 stored in the storage section 202 into the RAM or the like and executing the loaded control program 203. First, in a step S501, the controller 201 holds a chat room including a plurality of users. Next, in a step S502, the controller 201 receives a message from the chat application of the mobile terminal 102 (message-sending person-side terminal).

Next, in a step S503, the controller 201 stores and saves the received message in the storage section 202. Then, in a step S504, the controller 201 transmits the received message to other users in the chat room. Thus, the operation of the chat application server 107 is performed.

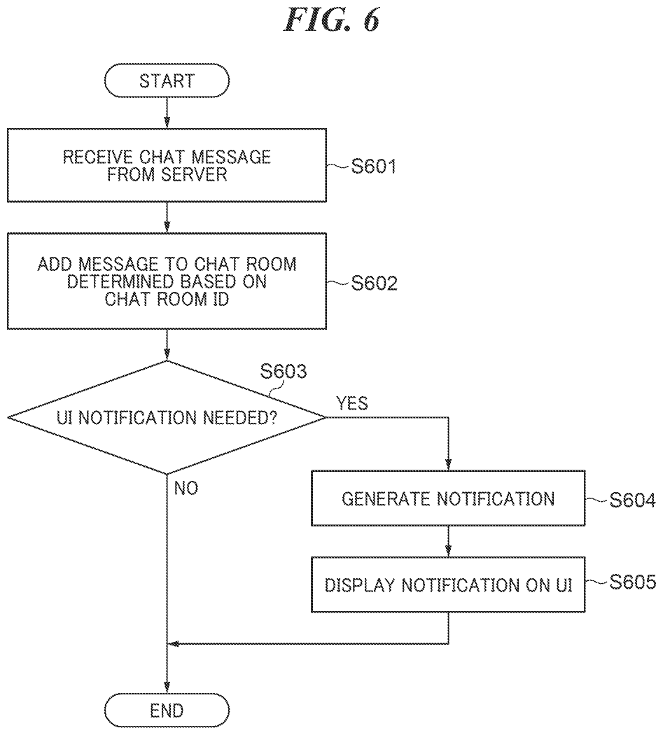

Next, a message reception process performed by the mobile terminal 104 will be described with reference to FIG. 6. The message reception process in FIG. 6 is realized by the controller 301 (CPU) of the mobile terminal 104 loading an associated control program stored in the storage section 302 into the RAM or the like and executing the loaded control program. First, in a step S601, the controller 301 receives a message from the chat application server 107. Next, in a step S602, based on a chat room ID for identifying a chat room, which is included in the message, the controller 301 notifies the message to the corresponding chat room.

Next, in a step S603, the controller 301 determines whether or not it is necessary to notify reception of the message to the user via the UI. Note that necessity/unnecessity of the notification is set by the user in advance, and a setting is stored in the storage section 302.

Then, if it is determined in the step S603 that the notification is needed (YES), the controller 301 proceeds to a step S604. On the other hand, if it is determined that the notification is not needed (NO), the controller 301 terminates the present process. In the step S604, the controller 301 generates the notification. Then, in a step S605, the controller 301 displays the notification on the display section 304 and causes the user to be informed of the notification by using the speaker 306 according to a setting. Thus operates the mobile terminal 104 having received the message.

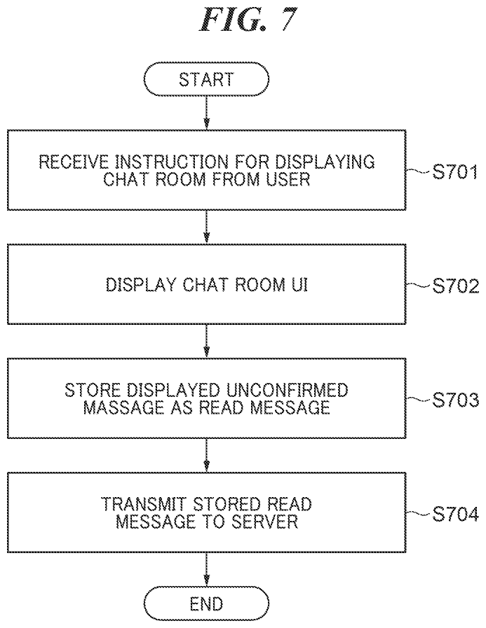

Next, a read message transmission process for transmitting a read message to the chat application server 107 when a message is displayed in a chat room of the mobile terminal 104 will be described with reference to FIG. 7. The message displaying process in FIG. 7 is realized by the controller 301 of the mobile terminal 104 loading an associated control program stored in the storage section 302 into the RAM or the like and executing the loaded control program. First, in a step S701, the controller 301 receives an instruction for displaying a chat room from the user. Next, in a step S702, the controller 301 displays the selected chat room on the display section 304. Specifically, the chat room is displayed as the UI.

Next, in a step S703, the controller 301 stores a latest displayed unconfirmed message in the storage section 302 as a read message. Then, in a step S704, the controller 301 transmits the read message stored in the storage section 302 to the chat application server 107. Thus, the read message transmission process is performed by the mobile terminal.

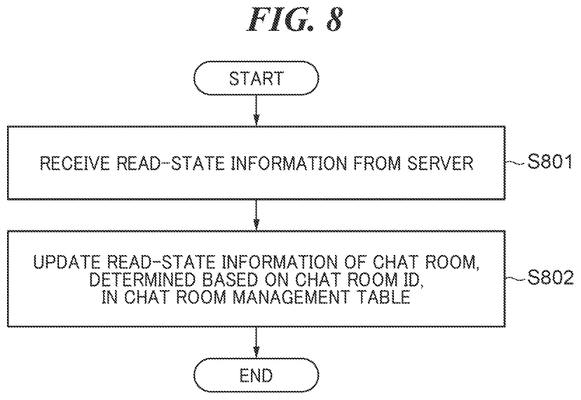

Next, a read-state information reception process performed by the mobile terminal 102 will be described with reference to FIG. 8. The read-state information reception process in FIG. 8 is realized by the controller 301 of the mobile terminal 102 loading an associated control program stored in the storage section 302 into the RAM or the like and executing the loaded control program.

First, in a step S801, the controller 301 receives read-state information from the chat application server 107. Next, in a step S802, based on a chat room ID for identifying a chat room, which is included in the read-state information, the controller 301 updates the read-state information of the corresponding chat room in a chat management table 901. Thus, the read-state information reception operation is performed.

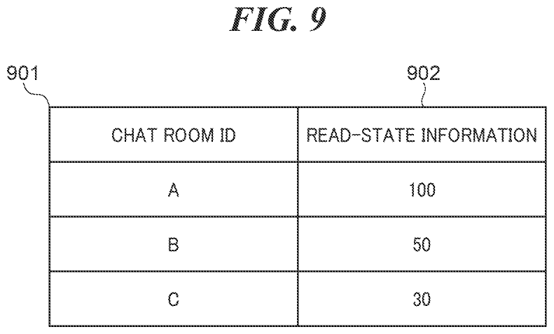

FIG. 9 shows an example of the chat management table 901 which is updated in the step S802. The chat management table 901 has been stored in the storage section 302. The chat management table 901 stores chat room IDs (chat room identifiers) and items of read-state information in association with each other.

That is, the chat management table 901 manages information on a chat room-by-chat room basis and holds read-state information 902 indicating how many messages have been read by a receiving person in each chat room. The character string (“read”) 403 indicating the read-state information is displayed based on this information when the chat room is displayed. For example, in a chat room A, the read-state information 902 is 100, which indicates that 100 messages are in the read state.

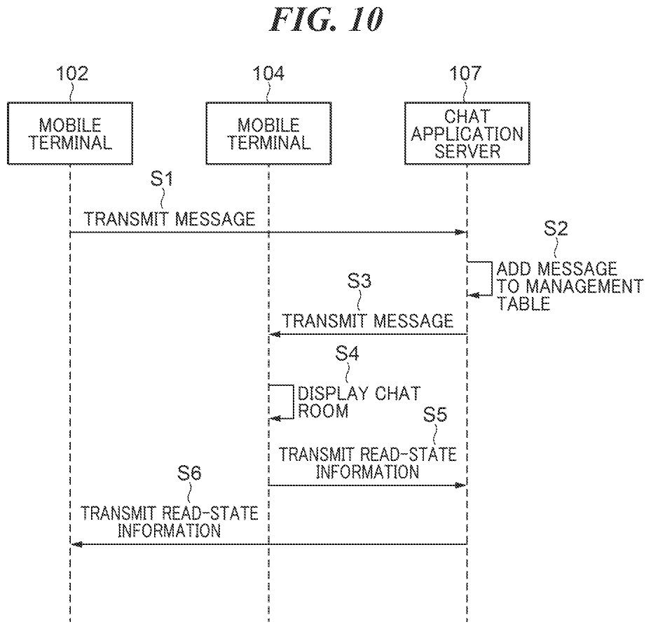

Next, a sequence of operations performed by the whole chat system using the chat application server 107, the mobile terminal 102, and the mobile terminal 104 will be described with reference to FIG. 10. First, the sending person 100 operates the mobile terminal 102 to transmit a message to the chat application server 107 (S1). In response to this, the chat application server 107 adds the message to the chat management table 901 (S2) and transmits the message to the mobile terminal 104 of the receiving person 103 (S3).

Next, the receiving person 103 operates the mobile terminal 104 to display a chat room (S4) and confirms the message. In response to this, the mobile terminal 104 transmits read-state information to the chat application server 107 (S5). Then, the chat application server 107 transmits the read-state information to the mobile terminal 102 (S6). With this, the sending person 100 can recognize that the message has been confirmed. Thus, the sequence of operations is performed by the whole chat system.

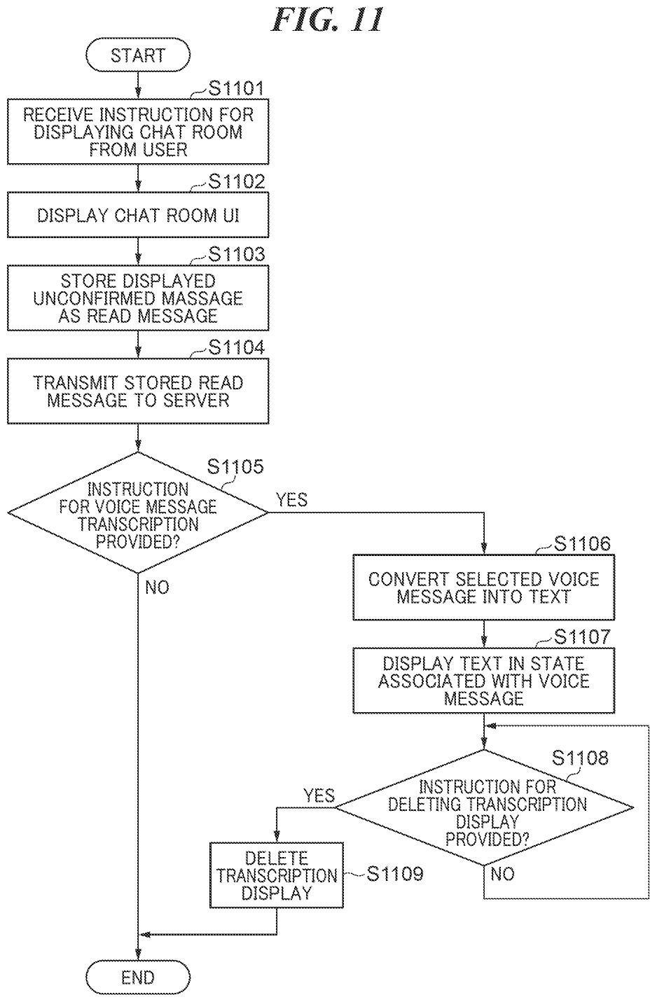

Next, a text message-displaying process for performing transcription of a voice message (converting a voice message into text) in a chat room of the mobile terminal 104 to display the text, according to a user's instruction, will be described with reference to FIG. 11. The text message-displaying process in FIG. 11 can be realized by the controller 301 loading an associated control program stored in the storage section 302 into the RAM or the like and executing the loaded control program. First, in a S1101, the controller 301 receives an instruction for displaying a chat room from the user. Next, in a S1102, the controller 301 displays the selected chat room on the display section 304.

Next, in a S1103, the controller 301 stores a latest displayed unconfirmed message in the storage section 302 as a read message. Next, in a S1104, the controller 301 transmits the read message stored in the storage section 302 to the chat application server 107.

Next, in a S1105, the controller 301 determines whether or not a voice message transcription instruction (instruction for converting the voice message into text) has been provided. If it is determined that the voice message transcription instruction has been provided (YES), the controller 301 proceeds to a step S1106. On the other hand, if it is determined that the voice message transcription instruction has not been provided (NO), the controller 301 terminates the text message-displaying process in FIG. 11.

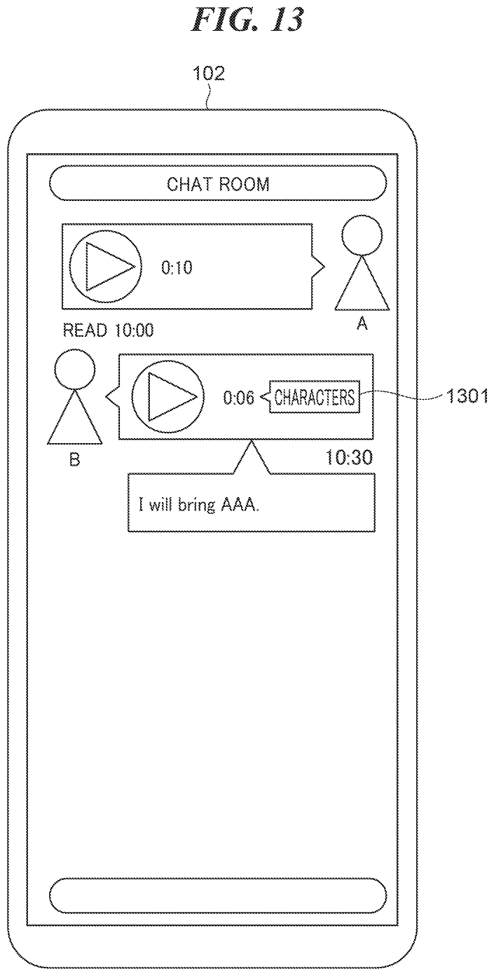

Note that the voice message transcription instruction (operation of the instruction unit) in the step S1105 can be provided by an action performed on the touch panel, such as a long-pressing operation or a slide operation of the corresponding voice message. The form of the voice message transcription instruction is not limited to this, but a dedicated instruction button, such as a transcription button 1301 (see FIG. 13) can be displayed, and the user can provide the voice message transcription instruction by performing an action on this button. FIG. 13 shows an example of display of the transcription button 1301 (word of “characters”) dedicated for transcription, provided within a display object of the mobile terminal 102 indicating the voice message. Note that the dedicated button is not limited to the button appearing in FIG. 13.

Thus, the controller 301 (instruction unit) can be configured to provide an instruction for converting content of a voice message into text in response to an action including a long-pressing operation or a slide operation performed on the voice message.

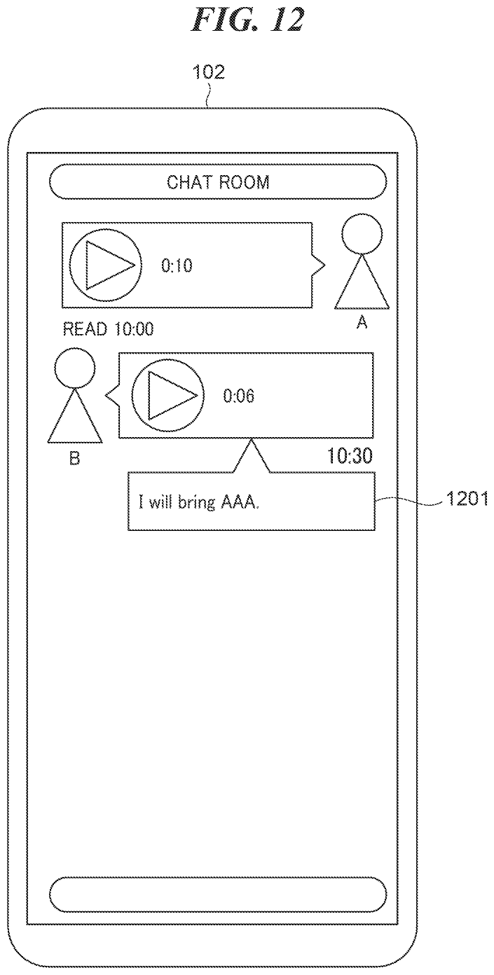

Next, in the step S1106, the controller 301 analyzes the voice of the selected voice message and converts the voice message into text. Next, in a step S1107, the controller 301 displays a transcription display 1201 which is a display of text generated by transcription of the voice message in the step S1106, on the display section 304, in a state associated with the voice message in the chat room in a display form different from the display of normal messages. FIG. 12 shows a state in which the transcription display 1201 is displayed on the display screen of the chat room displayed on the mobile terminal 102. In the illustrated example of associated display, shown in FIG. 12, a text display space is connected below the display object indicating the voice message, and the text is displayed in the text display space.

Next, in a step S1108, the controller 301 determines whether or not a transcription display deletion instruction for deleting the transcription display 1201 displayed in the step S110 has been provided by a deletion instruction section (deletion instruction unit). If it is determined that the transcription display deletion instruction has been provided (YES), the controller 301 proceeds to a step S1109. On the other hand, if it is determined that the transcription display deletion instruction has not been provided (NO), the controller 301 returns to the step S1108 to check for the transcription display deletion instruction.

As described above, in a case where a deletion instruction (transcription display deletion instruction) for deleting display (transcription display 1201) of text generated by transcription of a voice message is provided, the controller 301 (control unit) deletes the transcription display displayed on the display section 304. Note that the transcription display deletion instruction in the step S1108 can be provided by an action performed on the touch panel, such as long-pressing operation or a slide operation of the transcription display, similarly to the voice message transcription instruction. Further, the form of the transcription display deletion instruction is not limited to this, but a dedicated deletion instruction button can be displayed, and the user can provide the transcription display deletion instruction, for example, by performing an operation of tapping the displayed button or an operation of tapping an area other than the transcription display. Then, in the step S1109, the controller 301 deletes the transcription display 1201.

Although in the first embodiment, the processing for converting a voice message into text is performed by the mobile terminal 102, the configuration can be such that the mobile terminal 102 transmits a request for converting a voice message into text to the chat application server 107 having the function of converting a voice message into text, and receives text generated by transcription of the voice message from the chat application server 107 to display the text in the step S1107. Note that irrespective of whether a voice message is sent by a user himself/herself or received from a communication partner, the voice message can be displayed in a state in which a caption is associated with the voice message by the text message-displaying process in FIG. 11.

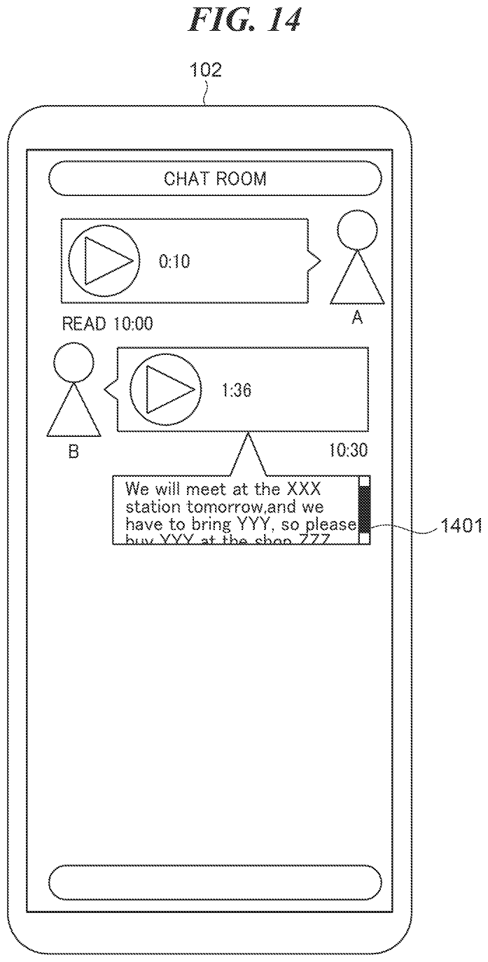

In a case where the voice message is a message of a long-time period, a phase generated by transcription (conversion into text) can be a long phrase. In such a case, if all of the phrase is displayed, the visibility can be degraded. In this case, as in the display denoted by reference numeral 1401 in FIG. 14, only part of the text can be displayed, and the text can be advanced by a slide operation on the transcription display. FIG. 14 shows an example in which text displayed in a state associated with a voice message is long and cannot be accommodated in the text display space on the display screen of the chat room of the mobile terminal 102. In this case, if the text cannot be accommodated in the text display space, by sliding the text, part which is not displayed is sequentially displayed.

Thus, in a case where text generated by transcription of the voice message cannot be accommodated in the text display space, the controller 301 moves the text within the text display space when a slide operation (specific operation) is received so as to enable the user to visually recognize the text.

As described above, even in a situation where a voice message cannot be reproduced, it is possible to confirm the content of the voice message by displaying text generated by transcription of the voice message. Further, since the transcription is performed according to an instruction from a user, it is possible to provide more convenience to the user.

As described above, the present invention provides the following configuration: First, the controller 301 (communication unit) transmits and receives a voice message in a chat room where chats are exchanged by a plurality of users. Next, in a case where a voice message transcription instruction is provided, the controller 301 (text conversion unit) converts the content of the voice message into text, and displays text generated by transcription of the voice message, in a form different from normal text messages, in the chat room.

Further, the configuration can be such that the controller 301 (control unit) displays text generated by transcription of a voice message in a state associated with the voice message, in the display section 304 (display unit) which displays the chat room.

Note that the configuration can be such that a request for transcription of a voice message is transmitted to the chat application server 107 and text generated by the transcription is received from the chat application server 107 to display the same on the mobile terminal 102. That is, the controller 301 (request transmission unit) transmits a request for generating text by transcription of a voice message to the chat application server 107 (external server) that is capable of generating text by transcription of a voice message. Further, the controller 301 (reception unit) receives the text generated by transcription of the voice message, which is transmitted from the chat application server 107 (external server). Then, the controller 301 (control unit) displays the text in the chat room in a state associated with the voice message. With this, it is possible to generate the text with high accuracy and associate the generated text with the voice message by using the chat application server 107 having high processing capability.

Next, a second embodiment of the present invention will be described. In the first embodiment, the description has been given of the method of displaying text generated by transcription of a voice message in the form different from the method of displaying a normal message. In the second embodiment, a description will be given of an operation of displaying text generated by transcription (conversion into text) in the same form as an existing message.

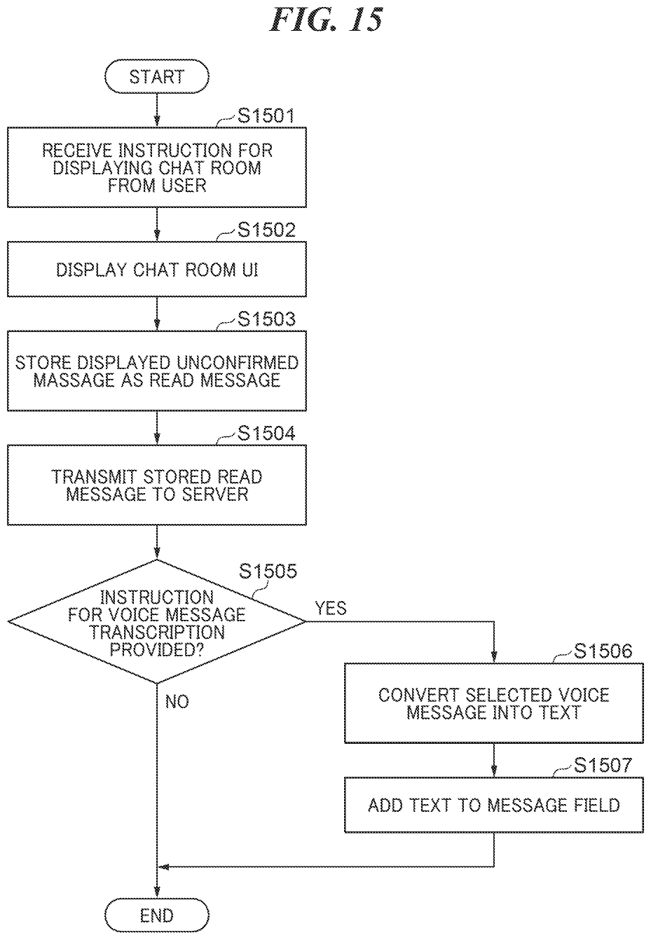

Next, with reference to FIG. 15, the description is given of a first variation of the text message-displaying process, for posting a message of text generated by transcription of the voice message in a chat room of the mobile terminal 102 in a message field according to a user's instruction. The first variation of the text message-displaying process in FIG. 15 is realized by the controller 301 loading an associated control program stored in the storage section 302 into the RAM or the like and executing the loaded control program. First, in a step S1501, the controller 301 receives an instruction for displaying a chat room from a user. Next, in a step S1502, the controller 301 displays the selected chat room on the display section 304.

Next, in a step S1503, the controller 301 stores a latest displayed unconfirmed message in the storage section 302 as a read message. Next, in a step S1504, the controller 301 transmits the read message stored in the storage section 302 to the chat application server 107. In a step S1505, the controller 301 determines whether or not a voice message transcription instruction has been provided. If it is determined that the voice message transcription instruction has been provided (YES), the controller 301 proceeds to a step S1506. On the other hand, if it is determined that the voice message transcription instruction has not been provided (NO), the controller 301 terminates the present process.

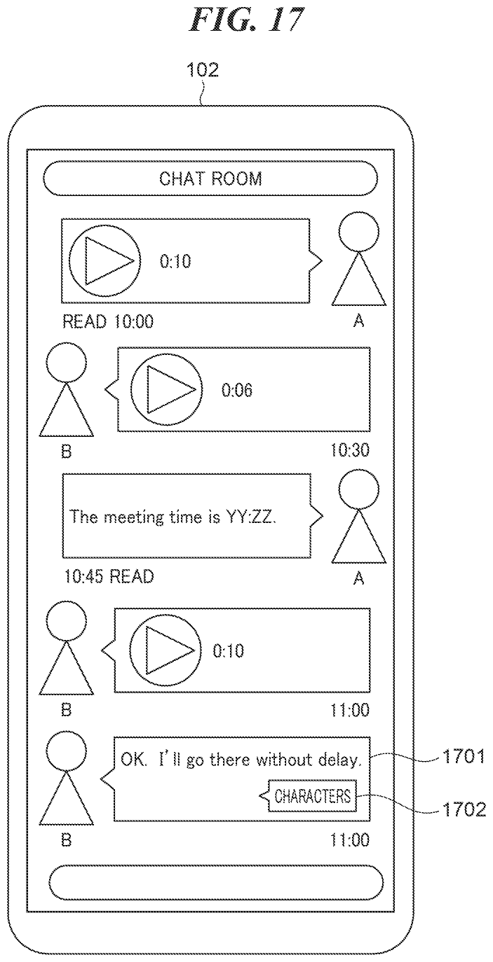

Next, in the step S1506, the controller 301 analyzes the voice of the selected voice message and converts the voice message into text. Then, in a step S1507, the controller 301 adds the text generated by transcription of the voice message in the step S1506 as a text message 1701 to a message field associated with a voice message field to which the voice message is added so as to display the text message 1701 on the display screen of the chat room in the same form as the normal message. FIG. 17 shows the display screen on the display section 304 of the mobile terminal 102, and the text denoted by the reference numeral 1701 is displayed in the same form as the normal chat message (post) without being associated with the voice message.

Note that, to the text message generated by transcription, a display 1702 indicating that transcription has been performed (conversion of the voice message into text has been performed) can be added so as to enable the user to distinguish the message from other text messages. Further, the text message generated by transcription can be highlighted by changing, for example, a color or shape of characters of the text message so as to enable the user to easily distinguish the text message from text message normally posted in a chat. Thus, the controller 301 (control unit) can display, for a text message generated by transcription of a voice message, a display object indicating that the text message has been converted from the corresponding voice message, on the display section 304.

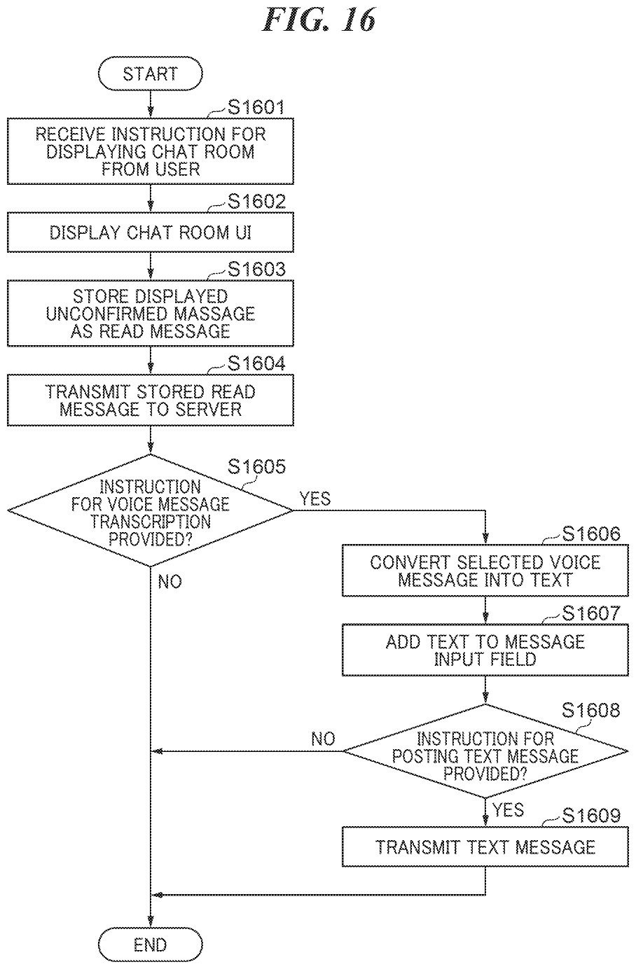

Although in the first variation of the text message-displaying process in FIG. 15, the text generated by transcription is directly displayed in the text message field associated with the voice message, a second variation of the text message-displaying process in which text is once input to the message input field 404 will be described with reference to FIG. 16. The second variation of the text message-displaying process in FIG. 16 can be realized by the controller 301 loading an associated control program stored in the storage section 302 into the RAM or the like and executing the loaded control program. First, in a step S1601, the controller 301 receives an instruction for displaying a chat room from a user. Next, in a step S1602, the controller 301 displays the selected chat room on the display section 304.

Next, in a step S1603, the controller 301 stores a latest displayed unconfirmed message in the storage section 302 as a read message. Next, in a step S1604, the controller 301 transmits the read message stored in the storage section 302 to the chat application server 107. Next, in a step S1605, the controller 301 determines whether or not a voice message transcription instruction has been provided. If it is determined that the voice message transcription instruction has been provided (YES), the controller 301 proceeds to a step S1606. On the other hand, if it is determined that the voice message transcription instruction has not been provided (NO), the controller 301 terminates the present process.

In the step S1606, the controller 301 analyzes the voice of the selected voice message and converts the voice message into text. Next, in a step S1607, the controller 301 inputs the text generated by transcription of the voice message in the step S1606 as a text message in the message input field 404 (posting field: see FIG. 4). When the text message is input in the message input field 404, it is possible to confirm the content of the voice message by reading the text message.

Next, in a step S1608, the controller 301 determines whether or not an instruction for posting the text message has been provided. If it is determined that the posting instruction has been provided (YES), the controller 301 proceeds to a step S1609. On the other hand, if it is determined that the posting instruction has not been provided (NO), the controller 301 terminates the present process. In the step S1609, the controller 301 transmits the text message to the chat application server 107. After the text message has been posted, the other users having received this message can also confirm the voice message by reading the text message generated by transcription.

Although in the variations of the text message-displaying process in FIGS. 15 and 16, the text generated by transcription is displayed as the text message in the message field, there is a possibility that the sending person deletes the original voice message after executing the transcription. In such a case, even after the voice message itself has been deleted from the chat room, the text message generated by transcription of the voice message can be left, resulting in a situation in which unnecessary messages or erroneous messages are left.

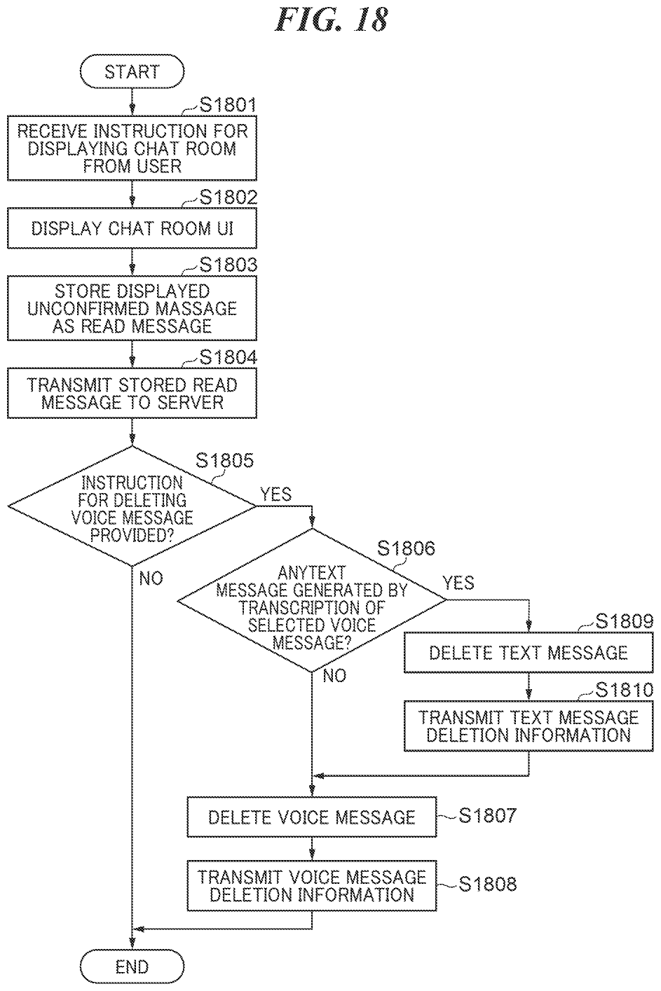

To solve this problem, a text message-deleting process for deleting a text message generated by transcription in accordance with deletion of the original voice message will be described with reference to FIG. 18. The text message-deleting process in FIG. 18 is realized by the controller 301 loading an associated control program stored in the storage section 302 into the RAM or the like and executing the loaded control program. First, in a step S1801, the controller 301 receives an instruction for displaying a chat room from a user. Next, in a step S1802, the controller 301 displays the selected chat room on the display section 304.

Next, in a step S1803, the controller 301 stores a latest displayed unconfirmed message in the storage section 302 as a read message. Next, in a step S1804, the controller 301 transmits the read message stored in the storage section 302 to the chat application server 107. Next, in a step S1805, the controller 301 determines whether or not an instruction for deleting the voice message has been provided. If it is determined that the instruction for deleting the voice message has been provided (YES), the controller 301 proceeds to a step S1806. On the other hand, if it is determined that the instruction for deleting the voice message has not been provided (NO), the controller 301 terminates the present process. Note that as the form of providing an instruction for deleting a voice message can be an operation of touching a dedicated button displayed on the display section 304, an operation of tapping the displayed voice message a plurality of times, or an operation of long-pressing the displayed voice message, but the instruction providing form is not limited to these.

In the step S1806, the controller 301 determines whether or not a text message exists which has been generated by transcription of the voice message for which the deletion instruction has been provided. If it is determined that the corresponding text message exists (YES), the controller 301 proceeds to a step S1809. On the other hand, if it is determined that the corresponding text message does not exist (NO), the controller 301 proceeds to a step S1807.

In the step S1807, the controller 301 deletes the selected voice message and displays the chat room from which the voice message has been deleted on the display section 304. Next, in a step S1808, the controller 301 transmits information on the deleted voice message to the chat application server 107.

On the other hand, in the step S1809, the controller 301 deletes the text message generated by transcription of the selected voice message and displays the chat room from which the text message generated by the transcription has been deleted on the display section 304. Then, in a step S1810, the controller 301 transmits information on the deleted text message generated by the transcription to the chat application server 107.

As described above, the message input field 404 (input unit) for inputting normal text and displaying the input text as a text message in a chat room is provided, and the controller 301 (control unit) automatically inputs text generated by transcription of a voice message in the message input field 404. With this, it is possible to post the text message corresponding to the voice message by a simple posting instructing action in the chat room. Thus, it is possible to post the message, both in voice and text, at the same time. Further, in a case where a deletion instruction is provided by operating the deletion instruction section (deletion instruction unit) for providing an instruction for deleting a voice message, the controller 301 (control unit) deletes the voice message and also deletes a text message generated by transcription of the voice message. With this, it is possible to delete the text message generated by transcription in accordance with deletion of the original voice message.

In the second embodiment, the description has been given of the method of converting a voice message into text and displaying the resulting text message at a time. However, in a case where the voice message has a length of a long time period, there are possibilities of taking much time to convert the voice message into text and degrading visibility due to display of a large volume of text. To solve this problem, in a third embodiment of the present invention, a description will be given of an operation of executing transcription in response to a voice message transcription instruction, only for a predetermined time period or for a predetermined number of characters.

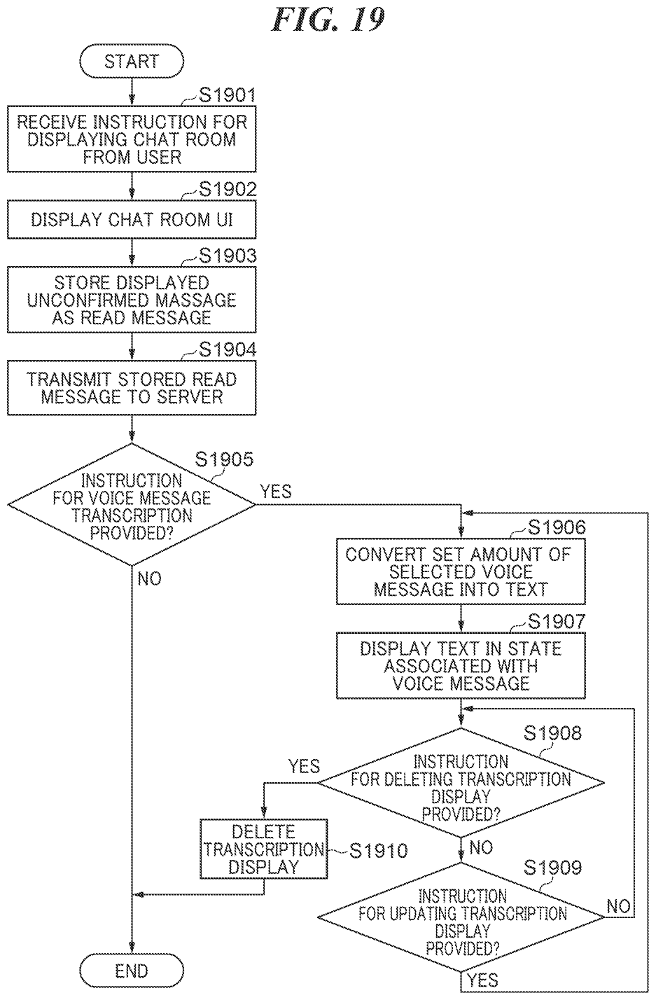

A description will be given of a third variation of the text message-displaying process for converting a voice message, in a case where a voice message transcription instruction is provided to the mobile terminal 104, only for a predetermined time period of the voice message or for a predetermined number of characters of text, with reference to FIG. 19. The third variation of the text message-displaying process in FIG. 19 can be realized by the controller 301 loading an associated control program stored in the storage section 302 into the RAM or the like and executing the loaded control program. First, in a step S1901, the controller 301 receives an instruction for displaying a chat room from a user. Next, in a step S1902, the controller 301 displays the selected chat room on the display section 304.

Next, in a step S1903, the controller 301 stores a latest displayed unconfirmed message in the storage section 302 as a read message. Next, in a step S1904, the controller 301 transmits the read message stored in the storage section 302 to the chat application server 107. Next, in a step S1905, the controller 301 determines whether or not a voice message transcription instruction has been provided. If it is determined that the voice message transcription instruction has been provided (YES), the controller 301 proceeds to a step S1906. On the other hand, if it is determined that the voice message transcription instruction has not been provided (NO), the controller 301 terminates the present process.

In the step S1906, the controller 301 analyzes the voice of the selected voice message and converts only a set amount of the voice message into text. Note that the amount in which the voice message is to be subjected to transcription in the step S1906 is determined by a predetermined value set in advance and stored in the storage section 302. The predetermined value is, for example, 10(%) corresponding to a predetermined amount of the message or 10 (seconds) corresponding to a predetermined time period of the message. Alternatively, the predetermined value can be the number of characters, such as 30 (characters). Thus, the storage section 302 stores the predetermined value for setting the amount in which the voice message is to be subjected to transcription such that an operation for changing the predetermined value can be performed.

Next, in a step S1907, the controller 301 displays a transcription display which is the display of text generated by transcription of the voice message in the step S1906 on the display section 304, in a state associated with the voice message in the chat room in a form different from the normal message display. Next, in a step S1908, the controller 301 determines whether or not a transcription display deletion instruction for deleting the transcription display displayed in the step S1907 has been provided. If it is determined that the transcription display deletion instruction has been provided (YES), the controller 301 proceeds to a step S1910. On the other hand, if it is determined that the transcription display deletion instruction has not been provided (NO), the controller 301 proceeds to a step S1909.

In the step S1909, the controller 301 determines whether or not a transcription display update instruction has been provided. If it is determined that the transcription display update instruction has been provided (YES), the controller 301 returns to the step S1906. On the other hand, if it is determined that the transcription display update instruction has not been provided (NO), the controller 301 returns to the step S1908.

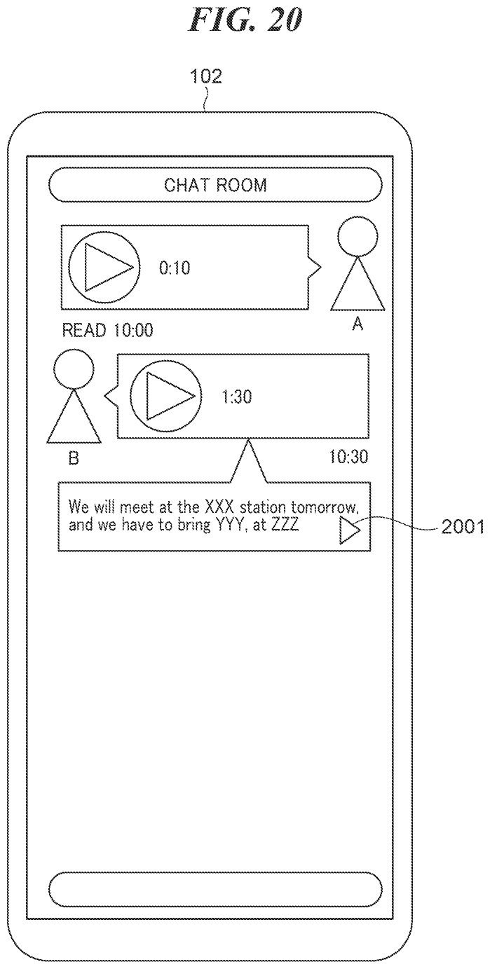

The transcription display update instruction in the step S1909 can be provided, for example, by performing an action, such as a long-pressing operation or a slide operation of the transcription display, on the touch panel. Further, a dedicated instruction button, such as a transcription display update button 2001 (update instruction section) appearing in FIG. 20, can be displayed to prompt a user to input the instruction. FIG. 20 is an explanatory diagram showing the display screen on the display section 304 of the mobile terminal 102, on which a display object 2001 having a triangular shape is displayed in a right end portion of the text displaying space on the display screen, and this display object is the transcription display update button 2001. In the step S1910, the controller 301 deletes the text generated by transcription from the display section 304.

As described above, the controller 301 (text conversion unit) converts the content of a voice message into text only by an amount set in advance. Further, in a case where an update instruction is provided by an operation of the transcription update button 2001 (update instruction unit), the controller 301 (text conversion unit) converts the content of the voice message into text only by the set amount again. Therefore, it is possible to transcribe the voice message only in a set amount desired by the user. Further, since the voice message is transcribed in the set amount again in a case where there is enough time to spare, it is very convenient for the user. Therefore, by performing transcription of the voice message for display only in the set amount, it is possible to confirm the content of the voice message even in a case where the whole voice message cannot be reproduced.

Next, a fourth embodiment of the present invention will be described. There is a case where the user desires to leave text generated by transcription as a memo or a case where the user desires to use text in other processing by copying the text. In the fourth embodiment, a description will be given of an operation of executing another action on text generated by transcription of a voice message.

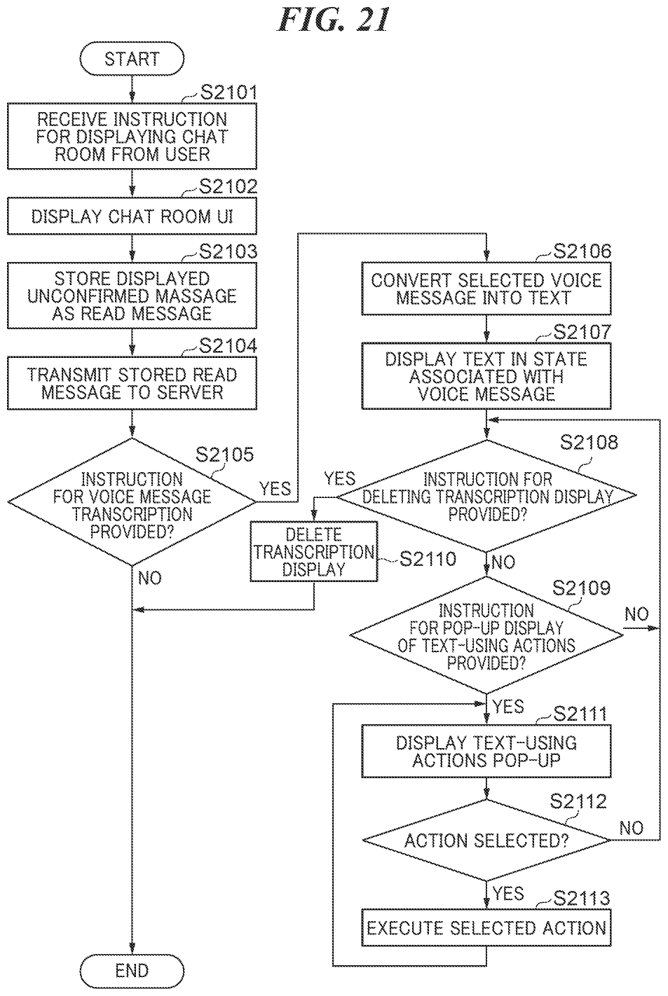

A fourth variation of the text message-displaying process performed in a case where an action instruction is provided with respect to the transcription display will be described with reference to FIG. 21. The fourth variation of the text message-displaying process in FIG. 21 can be realized by the controller 301 loading an associated control program stored in the storage section 302 into the RAM or the like and executing the loaded control program.

First, in a step S2101, the controller 301 receives an instruction for displaying a chat room from a user. Next, in a step S2102, the controller 301 displays the selected chat room on the display section 304. Next, in a step S2103, the controller 301 stores a latest displayed unconfirmed message in the storage section 302 as a read message. Next, in a step S2104, the controller 301 transmits the read message stored in the storage section 302 to the chat application server 107.

Next, in a step S2105, the controller 301 determines whether or not a voice message transcription instruction has been provided. If it is determined that the voice message transcription instruction has been provided (YES), the controller 301 proceeds to a step S2106. On the other hand, if it is determined that the t voice message transcription instruction has not been provided (NO), the controller 301 terminates the present process. Next, in the step S2106, the controller 301 analyzes the voice of the selected voice message and converts the voice message into text.

Next, in a step S2107, the controller 301 displays the transcription display 1201 (see FIG. 12) of text generated by transcription of the voice message in the step S2106 on the display section 304 in a state associated with the voice message in the chat room in a display form different from the display of a normal message. Next, in a step S2108, the controller 301 determines whether or not the transcription display deletion instruction for deleting the transcription display 1201 displayed in the step S2107 has been provided. If it is determined that the transcription display deletion instruction has been provided (YES), the controller 301 proceeds to a step S2110. On the other hand, if it is determined that the transcription display deletion instruction has not been provided (NO), the controller 301 proceeds to a step S2109.

Next, in the step S2109, the controller 301 determines whether or not an instruction for a popup display of text using actions has been provided with respect to the transcription display 1201. If it is determined that the popup display instruction has been provided (YES), the controller 301 proceeds to a step S2111. On the other hand, if it is determined that the popup display instruction has not been provided (NO), the controller 301 returns to the step S2108.

The popup display instruction in the step S2109 is provided, for example, by performing a long-pressing operation or a slide operation of the corresponding transcription display on the touch panel. This is not limitative, but a dedicated instruction button can be displayed, and the user can provide the popup display instruction by tapping this dedicated instruction button.

In the step S2110, the controller 301 deletes the transcription display from the display section 304. On the other hand, in the step S2111, the controller 301 displays a text using actions popup 2201 on the display section 304.

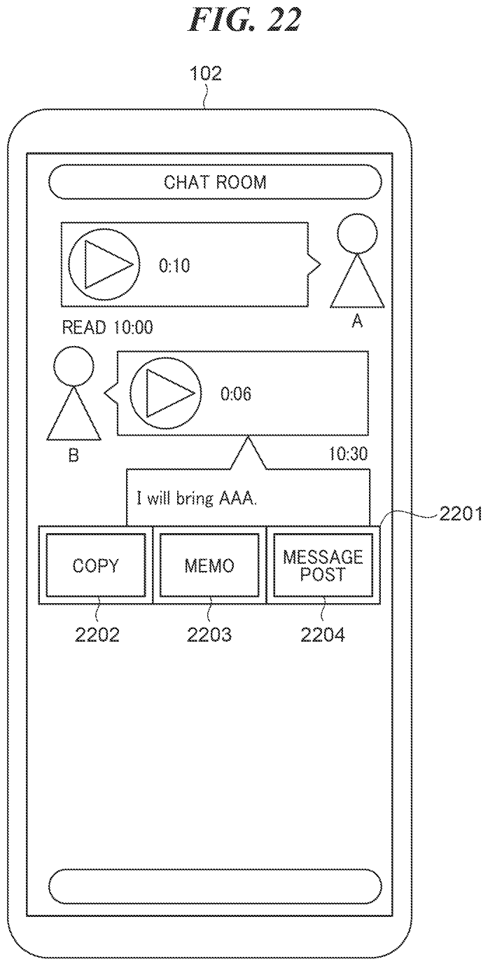

There are a variety of text using actions to be performed with respect to the transcription display. For example, the text using actions popup 2201 appearing in FIG. 22 includes a copy 2202, a memo 2203, and a message post 2204. The copy 2202 is an action for copying text generated by transcription, and the memo 2203 is an action for performing inputting text generated by transcription in a memo area in the chat room. Further, the message post 2204 is an action of posting text generated by transcription as a normal message. Thus, the popup display of the text using actions is performed.

Next, in a step S2112, the controller 301 determines whether or not an action has been selected from the text using actions popup 2201. If it is determined that an action has been selected (YES), the controller 301 proceeds to a step S2113. On the other hand, if it is determined that no action has been selected (NO), the controller 301 returns to the step S2108. In the step S2113, the controller 301 executes the selected action.

As described above, by performing a text using action with respect to the transcription display, it is possible to use the text generated by transcription, for other works or the like. Note that although in FIG. 22, the copy 2022, the memo 2023, and the message post 2024 are displayed, this is not limitative, but any other action can be added, or the actions displayed in FIG. 22 can be replaced by other actions. For example, call for calling all memos stored in the memo area in the past, summary for summarizing text generated by transcription of a voice message, or the like can be displayed. Note that for a simplified configuration, the action of summarizing the text can be performed, for example, by extracting only a key word, such as a place and date and time, or extracting a predetermined number of characters from the start of the text generated by transcription.

As described above, in a case where a text using instruction is provided by operating a text using instruction section (text using instruction unit) for providing an instruction for using text generated by transcription of a voice message, the controller 301 (text using unit) performs a text using action of using the text. Further, as shown in FIG. 22, the text using actions performed by the controller 301 (text using unit), includes, for example, the copy for copying the text, the memo for storing and saving the text in the storage section, and the post for posting the text in the chat room as a text message. Note that the form of text using action is not limited to these. Thus, it is possible to perform a text using action of using text generated by transcription of a voice message, which provides convenience for a user.

Although the above description has been given of the example in which a chat is performed between mobile terminals, the above-described operation can be also realized, for example, between PCs, such as a desktop-type PC and a laptop-type PC, or between a PC and a mobile terminal. In this case, the PC can be connected to a router by wired connection via a LAN cable or can be connected to a wireless router. Further, the laptop-type PC can be a portable type. However, it is necessary to install the application program (AP) according to the present invention and incorporate or externally mount a microphone for inputting voice and a speaker for outputting voice, in/on the PC.

By displaying a chat room itself as a three-dimensional image and also displaying text as a three-dimensional image, the user can three-dimensionally recognize the chat room and the text generated by transcription of a voice message, by wearing dedicated glasses, dedicated goggles, or the like. At this time, if an avatar of the user himself/herself and an avatar of a partner are set in advance and displayed in appropriate positions, the user can enjoy the chat more.

The user determines colors for chat types (a chat for friends, a chat for business, and a chat for a certain meeting), respectively, in advance. Then, a key word (such as date and time or a place) is extracted from text generated by transcription of the voice message, and the controller 301 determines a type of the chat and displays character strings of the text to which the associated color is applied. This enables the user to roughly grasp the content of the chat.

By performing a specific operation, such as a long-pressing operation, with respect to a reproduction icon, which has a triangular shape, of a voice message, it is also possible to display text generated by transcription of the voice message in the display area of the voice message without outputting voice. At this time, in a case where the text is not short enough to be displayed within the display area, it is also possible, by performing an operation of sliding the text, to sequentially slide and display the text to make the same visible.

By concluding an agreement that the voice message is necessarily converted to text with a management entity of the chat application server 107, it is possible to realize the variety of above-described processes by the mobile terminal with high accuracy without sending a request to the chat application server 107 each time.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-025959 filed Feb. 22, 2023, which is hereby incorporated by reference herein in its entirety.

What is claimed is:

1. A non-transitory computer-readable storage medium storing a program for causing a computer to execute a method of controlling an information processing apparatus, the control method comprising:
receiving an instruction for converting content of a voice message in a chat room where chats are posted by a plurality of users into characters;
causing the information processing apparatus to execute processing for converting the content of the voice message into characters; and
causing the information processing apparatus to display the characters in a state associated with the voice message in the chat room, based on the instruction.

2. The storage medium according to claim 1, wherein the information processing apparatus is caused to display the characters in a display form different from that of normal messages in the chat room.

3. The storage medium according to claim 1, wherein the information processing apparatus is caused to display, for the characters, a display object indicating that a corresponding voice message has been converted into characters.

4. The storage medium according to claim 1, wherein an action including an operation of long-pressing the voice message causes reception of an instruction for converting the content of the voice message into characters.

5. The storage medium according to claim 1, wherein the control method further comprises moving, in a case where text including the characters is not accommodated in a text display space, the text within the text display space according to a specific operation such that the text can be visually recognized.

6. The storage medium according to claim 1, wherein the control method further comprises:
receiving a deleting instruction for deleting the characters; and
deleting the characters based on the deletion instruction.

7. The storage medium according to claim 1, wherein the content of the voice message is converted into the characters based on a time period set in advance.

8. The storage medium according to claim 1, wherein the control method further comprises:
receiving a using action instruction for performing a using action of using the characters; and
performing the using action of using the characters based on the using action instruction.

9. The storage medium according to claim 8, wherein the using action includes copying the characters and posting the characters as a text message in the chat room.

10. The storage medium according to claim 1, wherein the processing for converting the content of the voice message into characters is processing for causing an external server to execute conversion of the content of the voice message into characters and receiving the characters.

11. The storage medium according to claim 1, wherein the information processing apparatus is a smartphone.

12. A method of controlling an information processing apparatus, comprising:
receiving an instruction for converting content of a voice message in a chat room where chats are posted by a plurality of users into characters;
causing the information processing apparatus to execute processing for converting the content of the voice message into characters; and
causing the information processing apparatus to display the characters in a state associated with the voice message in the chat room, based on the instruction.

13. An information processing apparatus comprising:
a reception unit configured to receive an instruction for converting content of a voice message in a chat room where chats are posted by a plurality of users into characters;
an execution unit configured to execute processing for converting the content of the voice message into characters; and
a display control unit configured to display the characters in a state associated with the voice message in the chat room, based on the instruction.
